(19) United States
(12) Patent Application Publication
(10) Pub. No.: US 2020/0258056 A1
(43) Pub. Date: Aug. 13, 2020

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventor: Jun ENDO, Nagoya-shi (JP)

(73) Assignee: TOYOTA JIDOSHA KABUSHIKI KAISHA, Toyota-shi (JP)

(21) Appl. No.: 16/733,297

(22) Filed: Jan. 3, 2020

(30) Foreign Application Priority Data
Feb. 8, 2019 (JP) 2019-021322

(51) Int. Cl. G06Q 10/10; G06Q 10/04; G06F 9/54

(52) U.S. Cl. CPC G06Q 10/1097; G06F 9/542; G06Q 10/047

(57) ABSTRACT

An information processing device according to one embodiment of the present disclosure includes: a TO-DO task information acquisition portion configured to acquire information about an unexecuted TO-DO task of a user; a plan information acquisition portion configured to acquire information about a forward plan of the user; and a TO-DO task execution support portion configured to notify, via a user terminal, the user of information on a facility related to execution of the TO-DO task in association with a plan accompanied with movement in the forward plan, the facility related to execution of the TO-DO task being placed around a moving route corresponding to the plan accompanied with movement.

### INCORPORATION BY REFERENCE

The disclosure of Japanese Patent Application No. 2019-021322 filed on Feb. 8, 2019 including the specification, drawings and abstract is incorporated herein by reference in its entirety.

### BACKGROUND

### 1. Technical Field

The present disclosure relates to an information processing device and so on.

### 2. Description of Related Art

For example, there has been known a technique in which a facility related to words of a TO-DO task registered via a TO-DO list application in a portable terminal is extracted in a region near a current location of the portable terminal, and a user of the portable terminal is notified that the TO-DO task can be executed (see Japanese Unexamined Patent Application Publication No. 2015-008537 (JP 2015-008537 A)).

### SUMMARY

However, in the above technique, only the facility in the region near the current location of the user is proposed. Accordingly, for some reasons, e.g., a reason that the user is in a hurry for the next business, the user might not be able to stop off in the proposed facility and execute the TO-DO task.

In consideration of the above problem, an object of the present disclosure is to provide an information processing device and so on that can make a proposal about execution of a TO-DO task at a more appropriate timing.

In order to achieve the above object, one aspect of the present disclosure provides an information processing device. The information processing device includes a TO-DO task information acquisition portion, a plan information acquisition portion, and a notification portion. The TO-DO task information acquisition portion is configured to acquire information about an unexecuted TO-DO task of a user. The plan information acquisition portion is configured to acquire information about a forward plan of the user. The notification portion is configured to notify, via a user terminal, the user of information on a facility related to execution of the TO-DO task in association with a plan accompanied with movement in the forward plan, the facility related to execution of the TO-DO task being placed around a moving route corresponding to the plan accompanied with movement.

With the present aspect, the information processing device can notify the user that the user can stop off in the facility related to execution of the TO-DO task and placed around the moving route corresponding to a forward plan of the user that is accompanied with movement (e.g., a facility where the user actually executes the TO-DO task, a facility where the user prepares for execution of the TO-DO task, and the like). On this account, the user can plan to stop off in the facility beforehand in accordance with the plan of the user. Accordingly, the information processing device can make a proposal related to execution of the TO-DO task at a more appropriate timing.

Further, in the above aspect, in a case where the moving route is defined in information corresponding to the plan accompanied with movement, the information being acquired by the plan information acquisition portion, the notification portion may notify the user of information on a facility related to execution of the TO-DO task and placed along the moving route, in association with the plan accompanied with movement.

With the present aspect, the information processing device can propose the facility placed along a specifically defined moving route corresponding to the plan accompanied with movement for the purpose of execution of the TO-DO task.

Further, in the above aspect, the notification portion may notify the user of the facility related to execution of the TO-DO task and placed along the moving route as a through-point between a departure place and a destination corresponding to the plan accompanied with movement. The notification portion may notify the user of a change of departure date and time or a change of the moving route, the change being made so that arrival date and time at the destination does not change.

With the present aspect, the information processing device can notify the user of the change of the departure date and time or the change of the moving route in consideration of a stop-off time in the facility, in addition to the notification of the facility placed along the moving route, for the purpose of execution of the TO-DO task. Hereby, the information processing device can improve the convenience for the user.

Further, in the above aspect, in a case where the moving route is not defined in information corresponding to the plan accompanied with movement, the information being acquired by the plan information acquisition portion, the notification portion may notify the user of information on a facility related to execution of the TO-DO task and placed around at least either one of a departure place and a destination corresponding to the plan accompanied with movement, in association with the plan accompanied with movement.

With the above aspect, in a case where a specific moving route is not defined for the plan accompanied with movement, the information processing device can propose a facility in which the user can stop off, the facility being placed around the departure place or the destination, for the purpose of execution of the TO-DO task.

Further, in the above aspect, in a case where the moving route is not defined in information corresponding to the plan accompanied with movement, the information being acquired by the plan information acquisition portion, the notification portion may notify the user of information on a facility related to execution of the TO-DO task and placed within a home range of the user in association with the plan accompanied with movement, the home range being grasped from a past movement history of the user.

With the above aspect, in a case where a specific moving route is not defined for the plan accompanied with movement, the information processing device can propose a facility, within the home range, that is highly likely to be used by the user as at least part of the moving route from the departure place to the destination for the purpose of execution of the TO-DO task.

Further, in the above aspect, the notification portion may notify the user of information on the facility related to execution of the TO-DO task and placed around the moving route so that the amount of money that the user is to pay to the facility related to execution of the TO-DO task is relatively restrained.

With the above aspect, the information processing device can improve the convenience for the user.

Further, in the above aspect, in a case where there is a plurality of facilities related to execution of the TO-DO task around the moving route, the notification portion may notify the user of information on facilities to which the user is to pay a relatively small amount of money.

With the above aspect, the information processing device can specifically restrain the amount of money that the user is to pay to the facility related to execution of the TO-DO task.

Further, in the above aspect, the notification portion may notify the user of a time period during which the user is to pay a relatively small amount of money to the facility related to execution of the TO-DO task and placed around the moving route.

With the above aspect, the information processing device can notify the user of a time period during which the amount of money to be paid for a product or a service is reduced in the facility, e.g., a time period for a time-limited sale or special offers for a limited time, in addition to the proposal of the facility around the moving route. Accordingly, the information processing device can specifically restrain the amount of money that the user is to pay to the facility related to execution of the TO-DO task.

Further, other aspects of the present disclosure are achievable in a form of an information processing method and a program.

With the above aspect, it is possible to provide an information processing device and so on that can make a proposal about execution of a TO-DO task at a more appropriate timing.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic view illustrating one example of a configuration of a TO-DO task execution support system;

FIG. 2 is a view illustrating one example of a hardware configuration of a schedule management server;

FIG. 3 is a functional block diagram illustrating one example of a functional configuration of the TO-DO task execution support system;

FIG. 4A is a flowchart diagrammatically illustrating one example of a TO-DO task execution support process performed by a TO-DO task execution support server;

FIG. 4B is a flowchart diagrammatically illustrating one example of the TO-DO task execution support process performed by the TO-DO task execution support server; and

FIG. 4C is a flowchart diagrammatically illustrating one example of the TO-DO task execution support process performed by the TO-DO task execution support server.

### DETAILED DESCRIPTION OF EMBODIMENTS

The following describes an embodiment for carrying out the disclosure with reference to the drawings.

Outline of TO-DO Task Execution Support System

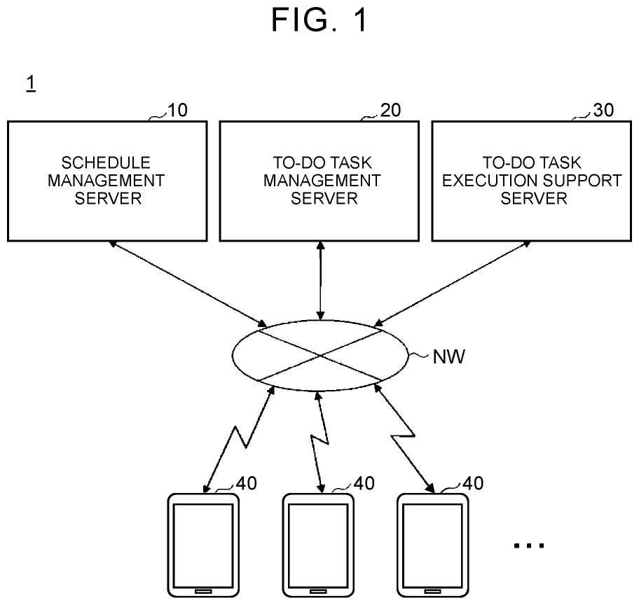

With reference to FIG. 1, the following describes an outline of a TO-DO task execution support system 1 according to the present embodiment.

The TO-DO task execution support system 1 includes a schedule management server 10, a TO-DO task management server 20, a TO-DO task execution support server 30, and a plurality of user terminals 40 corresponding to a plurality of users.

The TO-DO task execution support system 1 is configured such that the TO-DO task execution support server 30 supports execution of TO-DO tasks (things to do) of a user that are registered in the TO-DO task management server 20 by use of information (hereinafter referred to as “plan information”) about a plan of the user, the information being registered in the schedule management server 10. At this time, the TO-DO tasks include a TO-DO task (also referred to as “task”) for which a deadline is set and a TO-DO task for which a deadline is not set.

The schedule management server 10 is communicably connected to external devices such as the TO-DO task management server 20, the TO-DO task execution support server 30, and the user terminals 40 via a predetermined communication network NW that can include a movable body communication network in which a base station serves as a terminal, a satellite communication network using a communication satellite, an internet network, and the like.

The schedule management server 10 receives registration of plan information of each user via a predetermined application program (hereinafter referred to as “scheduler application”) installed in the user terminal 40 and manages the plan information of the user. Further, the schedule management server 10 transmits the plan information of the user to the user terminal 40 in response to a request via the scheduler application of the user terminal 40 and displays the plan information on a display device 46 of the user terminal 40.

A user of the schedule management server 10, that is, the user of the scheduler application may include a user except a user of the TO-DO task execution support system 1 (the TO-DO task execution support server 30). For a simple description, the following description is made on the premise that the user of the schedule management server 10 is the user of the TO-DO task execution support server 30 without exception.

The plan information includes date and time of a plan, a content of the plan, a place corresponding to the plan (a place where the plan is to be executed or a destination in a case where the content of the plan is to move), and so on. Further, the plan information may include a moving route to the place where the plan is to be executed or a moving route in a case where the content of the plan is to move.

The TO-DO task management server 20 is communicably connected to external devices such as the schedule management server 10, the TO-DO task execution support server 30, and the user terminals 40 via the communication network NW.

The TO-DO task management server 20 receives registration of a TO-DO task of each user via a predetermined application program (hereinafter referred to as “TO-DO task management application”) installed in the user terminal 40 and manages information about the TO-DO task of the user (hereinafter referred to as “TO-DO task information”). Further, the TO-DO task management server 20 transmits a TO-DO list including the TO-DO task information of the user to the user terminal 40 in response to a request via the scheduler application of the user terminal 40 and displays the TO-DO list on the display device 46 of the user terminal 40.

The TO-DO task information includes a content of the TO-DO task, a deadline of the TO-DO task, a place where the TO-DO is to be executed, a thing to be prepared for execution of the TO-DO task, and the like.

The user of the TO-DO task management server 20, that is, the user of the TO-DO task management application may include a user except a user of the TO-DO task execution support system 1 (the TO-DO task execution support server 30). The following description is made on the premise that the user of the TO-DO task management server 20 is the user of the TO-DO task execution support server 30 without exception.

The TO-DO task execution support server 30 (one example of an information processing device) is communicably connected to external devices such as the schedule management server 10, the TO-DO task management server 20, and the user terminals 40 via the communication network NW.

The TO-DO task execution support server 30 acquires, per user, plan information and TO-DO task information of the user from the schedule management server 10 and the TO-DO task management server 20. The TO-DO task execution support server 30 supports each user to execute the TO-DO task of the user via a predetermined application program (hereinafter referred to as “TO-DO task execution support application”) installed in the user terminal 40, based on the plan information of the user. Details will be described later.

The user terminal 40 is a portable terminal such as a smartphone, a mobile phone, a tablet terminal, or a laptop computer terminal, for example. Further, the user terminal 40 may be a fixed terminal such as a desktop computer terminal, for example.

The user terminal 40 is communicably connected to external devices such as the schedule management server 10, the TO-DO task management server 20, and the TO-DO task execution support server 30 via the communication network NW.

The user terminal 40 supports registration of a plan of the user and supports browsing of registered plan information via the scheduler application installed in the user terminal 40.

Further, the user terminal 40 supports registration of a TO-DO task of the user and supports browsing of registered TO-DO task information via the TO-DO task management application installed in the user terminal 40.

Further, the user terminal 40 supports execution of the TO-DO task of the user via the TO-DO task execution support application installed in the user terminal 40.

Configuration of TO-DO Task Execution Support System

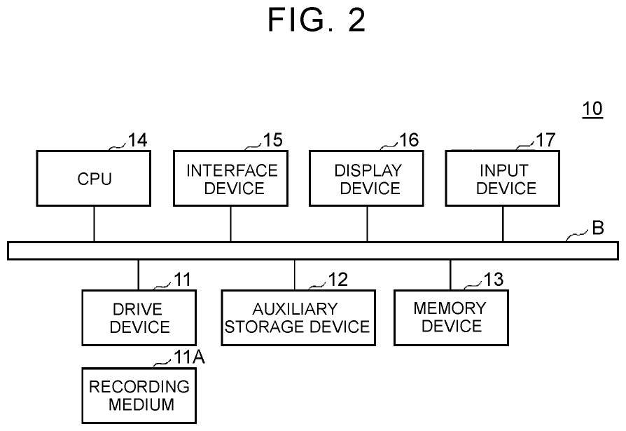

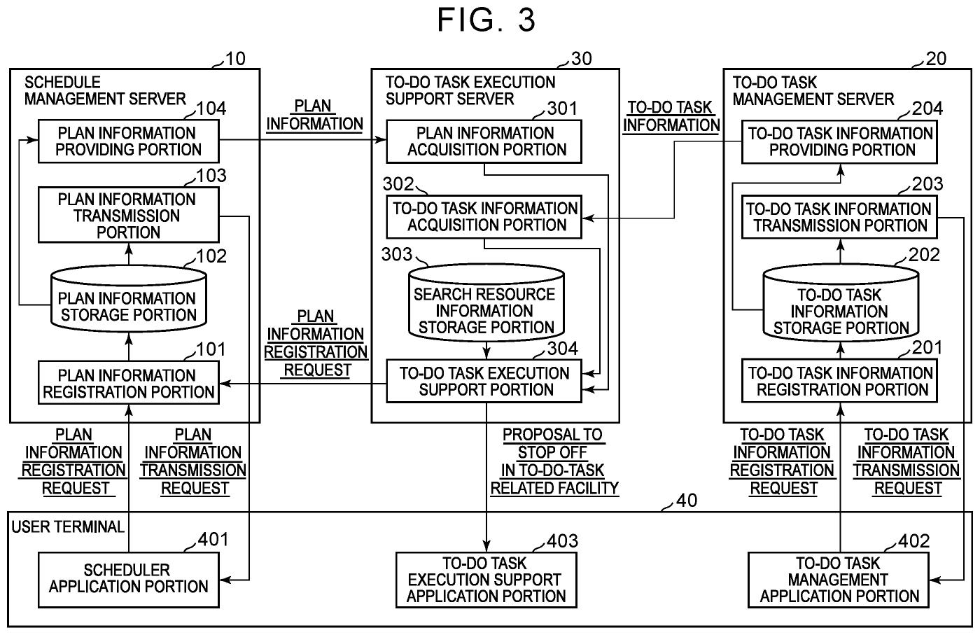

With reference to FIGS. 2 and 3 in addition to FIG. 1, the following describes the configuration of the TO-DO task execution support system 1.

FIG. 2 is a view illustrating one example of a hardware configuration of the TO-DO task execution support system 1. More specifically, FIG. 2 is a view illustrating one example of a hardware configuration of the schedule management server 10. FIG. 3 is a functional block diagram illustrating one example of a functional configuration of the TO-DO task execution support system 1.

Note that hardware configurations of the TO-DO task management server 20, the TO-DO task execution support server 30, and the user terminal 40 are generally the same as that of the schedule management server 10, and therefore, in the following description, the hardware configurations thereof are not illustrated and will be described with reference to FIG. 2. In the following description, the description of the TO-DO task management server 20 will be made by reading reference signs “11,” “11A,” “12,” “13,” “14,” “15,” “16,” “17,” and “B1” in FIG. 2 as “21,” “21A,” “22,” “23,” “24,” “25,” “26,” “27,” and “B2,” respectively. Further, the description of the TO-DO task execution support server 30 will be made by reading reference signs “11,” “11A,” “12,” “13,” “14,” “15,” “16,” “17,” and “B1” in FIG. 2 as “31,” “31A,” “32,” “33,” “34,” “35,” “36,” “37,” and “B3,” respectively. Also, the description of the user terminal 40 will be made by reading reference signs “11,” “11A,” “12,” “13,” “14,” “15,” “16,” “17,” and “B1” in FIG. 2 as “41,” “41A,” “42,” “43,” “44,” “45,” “46,” “47,” and “B4,” respectively.

Configuration of Schedule Management Server

The function of the schedule management server 10 may be implemented by given hardware or a combination of hardware and software. As illustrated in FIG. 2, the schedule management server 10 includes, for example, a drive device 11, an auxiliary storage device 12, a memory device 13, a CPU 14, an interface device 15, a display device 16, and an input device 17, and those devices are connected via a bus B1.

Programs that implement various functions of the schedule management server 10 are provided by a mobile recording medium 11A such as a compact disc read only memory (CD-ROM), a digital versatile disc read only memory (DVD-ROM), or a universal serial bus (USB) memory. When a recording medium 11A in which a program is stored is set in the drive device 11, the program is installed in the auxiliary storage device 12 from the recording medium 11A via the drive device 11. Further, the program may be downloaded from other computers via a communication network and installed in the auxiliary storage device 12.

In the auxiliary storage device 12, various programs installed therein are stored, and necessary files, data, and the like are also stored.

Upon receipt of an activation instruction for a program, the memory device 13 reads out the program from the auxiliary storage device 12 so that the program is stored in the memory device 13.

The CPU 14 executes various programs stored in the memory device 13 and implements various functions of the schedule management server 10 in accordance with the programs.

The interface device 15 is used as an interface to be connected to a communication network (e.g., the communication network NW).

The display device 16 displays, for example, a graphical user interface (GUI) in accordance with a program executed by the CPU 14.

The input device 17 is used for an operator, an administrator, or the like of the schedule management server 10 to input various operating instructions related to the schedule management server 10.

As illustrated in FIG. 3, the schedule management server 10 includes, as functional parts implemented by executing one or more programs installed in the auxiliary storage device 12 on the CPU 14, a plan information registration portion 101, a plan information transmission portion 103, and a plan information providing portion 104, for example. Further, the schedule management server 10 uses a plan information storage portion 102 or the like. The plan information storage portion 102 can be achieved by use of the auxiliary storage device 12 or an external storage device or the like communicably connected to the schedule management server 10, for example.

The plan information registration portion 101 registers plan information of the user in the plan information storage portion 102 in response to a plan information registration request received from the user terminal 40. More specifically, the plan information registration portion 101 may register date and time designated by the request, a content of the plan, other participants to the plan, and the like in the plan information storage portion 102 as plan information of the user corresponding to user identification information (e.g., a user ID (identifier) unique to each user or the like) designated by the request. Hereby, the user can register various pieces of information (plan information) about the plan of the user in the schedule management server 10 via the user terminal 40.

Further, in response to the plan information registration request from the TO-DO task execution support server 30, the plan information registration portion 101 registers various pieces of information designated by the request as the plan information corresponding to the user identification information designated by the request. Details will be described later.

Plan information of each user is registered (stored) in the plan information storage portion 102. More specifically, a timetable database for each user is held in the plan information storage portion 102, and plan information of each user is registered in a corresponding timetable database.

In response to a plan information transmission request received from the user terminal 40, the plan information transmission portion 103 transmits plan information of the user to the user terminal 40 as a source of the plan information transmission request and displays the plan information on the display device 46 via the scheduler application of the user terminal 40. Hereby, the user can browse (check) own plan information registered in the schedule management server 10 via the user terminal 40.

Further, the plan information transmission portion 103 may transmit, per user, a reminder related to plan information registered in the plan information storage portion 102 to the user terminal 40 and provide a push notification of the reminder via the scheduler application. More specifically, the plan information transmission portion 103 may provide a push notification of a reminder at a timing of date and time (e.g., date and time of start) of a plan corresponding to the plan information or at a predetermined timing (e.g., one hour before the date and time of the plan, or the like) set in advance based on the date and time of the plan.

The plan information providing portion 104 provides plan information of each user to the TO-DO task execution support server 30. At this time, plan information to be provided is plan information corresponding to a forward plan. For example, every time a plan information provision request is received from the TO-DO task execution support server 30 at any time or regularly, the plan information providing portion 104 may transmit plan information of each user to the TO-DO task execution support server 30. Further, in response to a plan information provision request received from the TO-DO task execution support server 30 to request periodical provision of plan information, the plan information providing portion 104 may automatically transmit plan information of each user to the TO-DO task execution support server 30 at a regular timing determined by the request.

Configuration of TO-DO Task Management Server

Similarly to the schedule management server 10 or the like, the function of the TO-DO task management server 20 may be implemented by given hardware or a combination of hardware and software. As illustrated in FIG. 2, the TO-DO task management server 20 includes, for example, a drive device 21, an auxiliary storage device 22, a memory device 23, a CPU 24, an interface device 25, a display device 26, and an input device 27, and those devices are connected via a bus B2.

The hardware configuration of the TO-DO task management server 20 is generally the same as that of the schedule management server 10 or the like, and therefore, a detailed description thereof is omitted.

As illustrated in FIG. 3, the TO-DO task management server 20 includes a TO-DO task information registration portion 201, a TO-DO task information transmission portion 203, and a TO-DO task information providing portion 204 as functional parts implemented by executing, on the CPU 24, one or more programs installed in the auxiliary storage device 22, for example. Further, the TO-DO task management server 20 uses a TO-DO task information storage portion 202. The TO-DO task information storage portion 202 can be achieved by use of the auxiliary storage device 22 or an external storage device or the like communicably connected to the TO-DO task management server 20, for example.

The TO-DO task information registration portion 201 registers TO-DO task information of the user in the TO-DO task information storage portion 202 in response to a TO-DO task information registration request received from the user terminal 40. More specifically, the TO-DO task information registration portion 201 may register, in the TO-DO task information storage portion 202, a content of a TO-DO task designated by the request, a deadline of the TO-DO task, a place where the TO-DO task is to be executed, a thing to be prepared for execution of the TO-DO task, and the like as TO-DO task information of the user corresponding to user identification information designated by the request. Hereby, the user can register various pieces of information (TO-DO task information) about a TO-DO task of the user in the TO-DO task management server 20 via the user terminal 40.

TO-DO task information of each user is registered (stored) in the TO-DO task information storage portion 202. More specifically, a TO-DO list database for each user is held in the TO-DO task information storage portion 202, and TO-DO task information of each user is registered in a corresponding TO-DO list database.

In response to a TO-DO task information transmission request received from the user terminal 40, the TO-DO task information transmission portion 203 transmits TO-DO task information of the user to the user terminal 40 as a source of the TO-DO task information transmission request and displays the TO-DO task information (a TO-DO list) on the display device 46 via the TO-DO task management application of the user terminal 40. Hereby, the user can browse (check) own plan information registered in the TO-DO task management server 20 via the user terminal 40.

Further, the TO-DO task information transmission portion 203 may transmit, per user, a reminder related to TO-DO task information registered in the TO-DO task information storage portion 202 to the user terminal 40 and provide a push notification of the reminder via the TO-DO task management application. More specifically, the TO-DO task information transmission portion 203 may provide a push notification of a reminder at a timing of a deadline of the TO-DO task information or a predetermined timing (e.g., one hour before date and time of the deadline or the like) set in advance based on the deadline.

The TO-DO task information providing portion 204 provides TO-DO task information of each user to the TO-DO task execution support server 30. At this time, the TO-DO task information to be provided is TO-DO task information corresponding to an unexecuted TO-DO task. For example, every time new TO-DO task information is registered, the TO-DO task information providing portion 204 may transmit the TO-DO task information thus newly registered to the TO-DO task execution support server 30. Further, every time a TO-DO task information provision request is received from the TO-DO task execution support server 30 at any time or regularly, the TO-DO task information providing portion 204 may transmit TO-DO task information of each user to the TO-DO task execution support server 30. Further, in response to a TO-DO task information provision request received from the TO-DO task execution support server 30 to request periodical provision of TO-DO task information, the TO-DO task information providing portion 204 may automatically transmit TO-DO task information of each user to the TO-DO task execution support server 30 at a predetermined timing defined by the request.

Configuration of TO-DO Task Execution Support Server

Similarly to the schedule management server 10 or the like, the function of the TO-DO task execution support server 30 may be implemented by given hardware or a combination of hardware and software. As illustrated in FIG. 2, the TO-DO task execution support server 30 includes, for example, a drive device 31, an auxiliary storage device 32, a memory device 33, a CPU 34, an interface device 35, a display device 36, and an input device 37, and those devices are connected via a bus B3.

The hardware configuration of the TO-DO task execution support server 30 is generally the same as that of the schedule management server 10 or the like, and therefore, a detailed description thereof is omitted.

As illustrated in FIG. 3, the TO-DO task execution support server 30 includes a plan information acquisition portion 301, a TO-DO task information acquisition portion 302, and a TO-DO task execution support portion 304 as functional parts implemented by executing, on the CPU 34, one or more programs installed in the auxiliary storage device 32, for example. Further, the TO-DO task execution support server 30 uses a search resource information storage portion 303. The search resource information storage portion 303 can be achieved by use of the auxiliary storage device 32 or an external storage device or the like communicably connected to the TO-DO task execution support server 30, for example.

The plan information acquisition portion 301 acquires plan information of each user that is received from the schedule management server 10. For example, the plan information acquisition portion 301 may acquire the plan information of each user from the schedule management server 10 by transmitting a plan information provision request to the schedule management server 10.

The TO-DO task information acquisition portion 302 acquires TO-DO task information of each user that is received from the TO-DO task management server 20. For example, the TO-DO task information acquisition portion 302 may acquire the TO-DO task information of each user from the TO-DO task management server 20 by transmitting a TO-DO task information provision request to the TO-DO task management server 20. Further, the TO-DO task information acquisition portion 302 may acquire newly registered TO-DO task information that is automatically transmitted from the TO-DO task management server 20.

Resource information (hereinafter referred to as “search resource information”) is stored in the search resource information storage portion 303 as described later. The resource information is used when the TO-DO task execution support portion 304 searches for facilities (hereinafter referred to as “TO-DO-task related facilities”) related to execution of a TO-DO task. For example, map information and point-of-interest (POI) information are stored in the search resource information storage portion 303. Further, web crawl information about a price or the like of each facility included in the POI information, and the like may be stored in the search resource information storage portion 303. Further, positional information including a current position of each user may be stored in the search resource information storage portion 303. The positional information of the user may be acquired based on various pieces of information acquired from the user terminal 40 (e g, positioning information of a global navigation satellite system (GNSS) module provided in the user terminal 40, internet protocol (IP) address information, base station information, and the like). Further, movement history information of each user may be stored in the search resource information storage portion 303. The movement history information of the user may be formed by the positional information of the user.

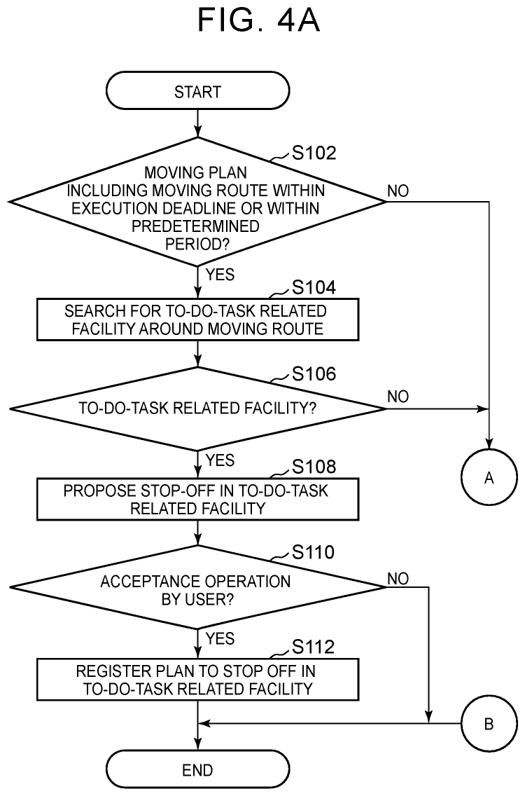

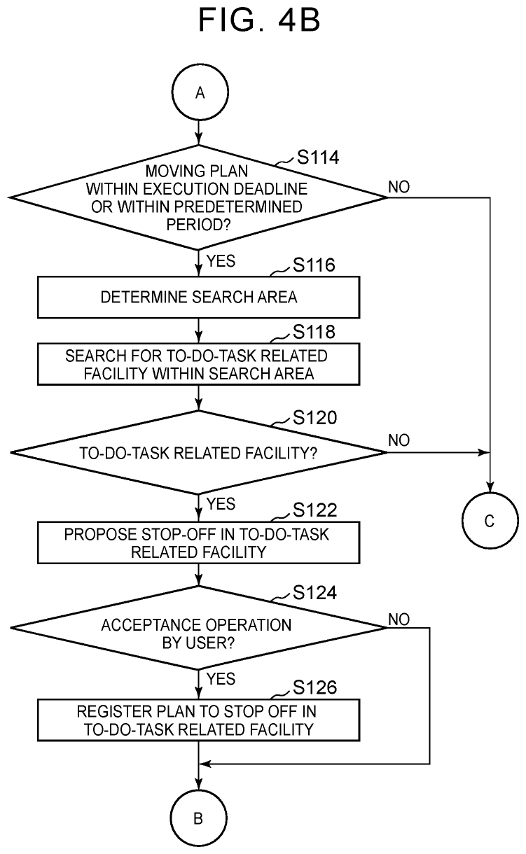

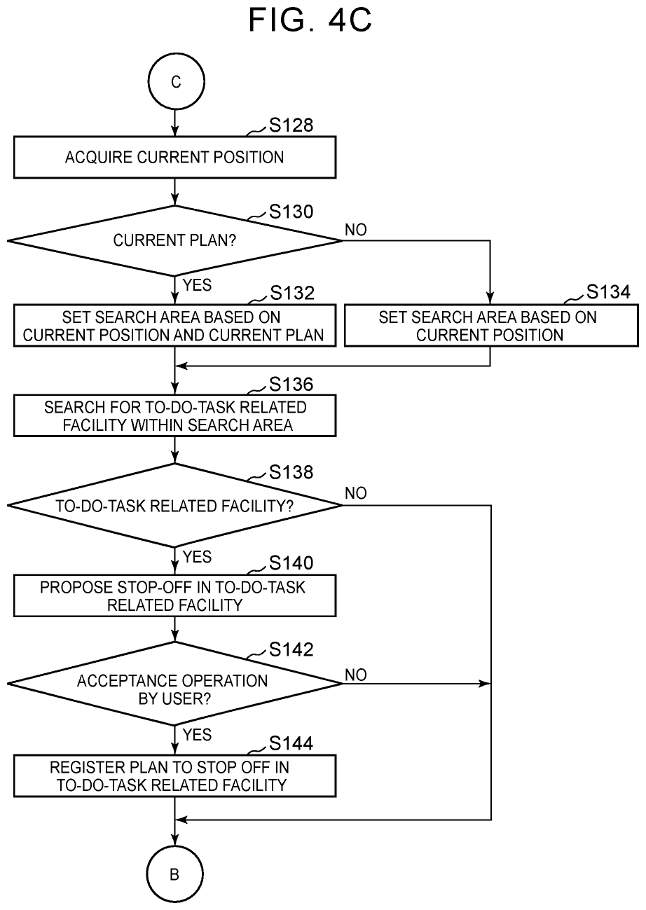

The TO-DO task execution support portion 304 (one example of a notification portion) supports, per user, execution of a TO-DO task of each piece of TO-DO task information acquired by the TO-DO task information acquisition portion 302 based on plan information of the user that is acquired by the plan information acquisition portion 301. Details will be described later (see FIGS. 4A to 4C).

Configuration of User Terminal

Similarly to the schedule management server 10 or the like, the function of the user terminal 40 may be implemented by given hardware or a combination of hardware and software. As illustrated in FIG. 2, the user terminal 40 includes, for example, a drive device 41, an auxiliary storage device 42, a memory device 43, a CPU 44, an interface device 45, a display device 46, and an input device 47, and those devices are connected via a bus B4.

The hardware configuration of the user terminal 40 is generally the same as that of the TO-DO task management server 20, and therefore, a detailed description thereof is omitted.

As illustrated in FIG. 3, the user terminal 40 includes a scheduler application portion 401 as a functional part implemented by executing, by the CPU 44, a scheduler application installed in the auxiliary storage device 42, for example. Further, the user terminal 40 includes a TO-DO task management application portion 402 as a functional part implemented by executing, by the CPU 44, a TO-DO task management application installed in the auxiliary storage device 42, for example. Further, the user terminal 40 includes a TO-DO task execution support application portion 403 as a functional part implemented by executing, by the CPU 44, a TO-DO task execution support application installed in the auxiliary storage device 42, for example.

Note that at least two of the scheduler application, the TO-DO task management application, and the TO-DO task execution support application may be put together in one application program in which functions of the at least two of them are integrated.

The scheduler application portion 401 supports the user to register plan information in the schedule management server 10. More specifically, the scheduler application portion 401 may transmit a plan information registration request in response to an operation input by the user on a predetermined operation screen (graphical user interface (GUI)) related to the scheduler application.

Further, the scheduler application portion 401 supports the user to browse plan information registered in the schedule management server 10. More specifically, the scheduler application portion 401 may transmit a plan information transmission request in response to an operation input by the user on a predetermined operation screen related to the scheduler application and displayed on the display device 46. Hereby, the scheduler application portion 401 can display, on the display device 46, the registered plan information of the user in a predetermined display form under control of the schedule management server 10.

Further, the scheduler application portion 401 notifies the user of various pieces of information related to plan information registered in the schedule management server 10 under control of the schedule management server 10. For example, the scheduler application portion 401 may display, on the display device 46, a reminder about plan information of the user, as described above.

The TO-DO task management application portion 402 supports the user to register TO-DO task information in the TO-DO task management server 20. More specifically, the TO-DO task management application portion 402 may transmit a TO-DO task information registration request to the TO-DO task management server 20 in response to an operation input by the user on a predetermined operation screen related to the TO-DO task management application and displayed on the display device 46.

Further, the TO-DO task management application portion 402 supports the user to browse TO-DO task information registered in the TO-DO task management server 20. More specifically, the TO-DO task management application portion 402 may transmit a TO-DO task information transmission request in response to an operation input by the user on a predetermined operation screen related to the TO-DO task management application and displayed on the display device 46. Hereby, the TO-DO task management application portion 402 can display, on the display device 46, registered TO-DO task information of the user in a predetermined display form (e.g., a list form) under control of the TO-DO task management server 20.

Further, the TO-DO task management application portion 402 notifies the user of various pieces of information related to TO-DO task information registered in the TO-DO task management server 20 under control of the TO-DO task management server 20. For example, the TO-DO task management application portion 402 may display, on the display device 46, a reminder about TO-DO task information of the user, as described above.

The TO-DO task execution support application portion 403 supports execution of a TO-DO task corresponding to TO-DO task information of the user that is registered in the TO-DO task management server 20 under control of the TO-DO task execution support server 30. Details will be described later (see FIGS. 4A to 4C).

TO-DO Task Execution Support Process

With reference to FIGS. 4A to 4C, the following describes a process (hereinafter referred to as “TO-DO task execution support process”) performed by the TO-DO task execution support server 30.

FIGS. 4A to 4C are flowcharts diagrammatically illustrating one example of the TO-DO task execution support process performed by the TO-DO task execution support server 30 (the TO-DO task execution support portion 304). The processes of those flowcharts are performed per TO-DO task information corresponding to an unexecuted TO-DO task. For example, those flowcharts are performed when new TO-DO task information is registered in the TO-DO task management server 20. Further, those flowcharts may be performed regularly (e.g., every few hours, every few days, or the like) on TO-DO task information the forward plan (see steps S112, S126, S144 described later) of which has not been registered in the schedule management server 10. The forward plan is a plan to stop off in a facility (hereinafter referred to as “TO-DO-task related facility”) related to execution of a TO-DO task.

As illustrated in FIG. 4A, in step S102, when a deadline (hereinafter referred to as “execution deadline”) is set for a TO-DO task, the TO-DO task execution support portion 304 determines, based on plan information acquired by the plan information acquisition portion 301, whether or not the plan information includes, within a forward execution deadline, a plan (hereinafter referred to as “moving plan”) of the user that is accompanied with movement for which a moving route is defined. Further, when the execution deadline is not set for the TO-DO task, the TO-DO task execution support portion 304 determines whether or not the plan information includes, within a forward predetermined period (e.g., within a week), a moving plan of the user for which a moving route is defined. The moving plan includes, for example, a plan to move to a given destination and a plan necessary to be executed after the user moves from a base point such as a home or an office (e.g., a plan to go to a leisure facility or the like). When the plan information includes, within the forward execution deadline or the forward predetermined period, a moving plan for which a moving route is defined, the TO-DO task execution support portion 304 proceeds to step S104, and when the plan information does not include a moving plan for which a moving route is defined, the TO-DO task execution support portion 304 proceeds to step S114 (see FIG. 4B).

Note that, in this step, even in a case where the TO-DO task has a deadline, when a period up to the deadline is relatively long (e.g., one month or more), the TO-DO task execution support portion 304 may deal with the TO-DO task in the same manner as a case where the deadline is not set. This may apply to step S112 described later.

In a case where the plan information includes a plurality of moving plans each for which a moving route is defined, the processes of steps S104 to S112 are executed on each of the moving plans.

In step S104, based on search resource information (road information and POI information) of the search resource information storage portion 303, the TO-DO task execution support portion 304 searches for a TO-DO-task related facility around the moving route defined in the plan information and proceeds to step S106. At this time, the TO-DO-task related facility may include a facility where the user actually executes the TO-DO task (e.g., a supermarket in a case where the TO-DO task is to “buy eggs,” and the like) and a facility where the user prepares for execution of the TO-DO task (e.g., a home center or the like where the user purchases a repair tool in a case where the TO-DO task is to “repair a house”). Further, the TO-DO task execution support portion 304 may search for a TO-DO-task related facility along the moving route defined in the plan information or may further enlarge a search range and search for a TO-DO-task related facility along other road links around a road link included in the moving route defined in the plan information.

In step S106, the TO-DO task execution support portion 304 determines whether the TO-DO-task related facility is found or not in the process of step S104. When the TO-DO-task related facility is found, the TO-DO task execution support portion 304 proceeds to step S108, and when the TO-DO-task related facility is not found, the TO-DO task execution support portion 304 proceeds to step S114 (see FIG. 4B).

Note that, when the TO-DO-task related facility is not found in step S106, this process may be ended.

In step S108, the TO-DO task execution support portion 304 notifies, via the user terminal 40, the user of a stop-off proposal, suitable for the moving plan, that proposes stop-off in the found TO-DO-task related facility, and the TO-DO task execution support portion 304 proceeds to step S110. At this time, in a case where a plurality of TO-DO-task related facilities is found, the TO-DO task execution support portion 304 may propose all the TO-DO-task related facilities as stop-off points or may propose some of the TO-DO-task related facilities as stop-off points. For example, in a case where the user has to pay money for execution of the TO-DO task to the TO-DO-task related facility, the TO-DO task execution support portion 304 may propose some TO-DO-task related facilities available at a relatively low price, a TO-DO-task related facility available at a lowest price, or the like as stop-off points based on search resource information (web crawl information) in the search resource information storage portion 303. This allows the user to pay a relatively small amount of money for execution of the TO-DO task without searching for a TO-DO-task related facility available at a relatively low price by himself or herself. As a result, the TO-DO task execution support server 30 can improve the convenience for the user. Further, in a case where a TO-DO-task related facility to be proposed has a time period (hereinafter referred to as “special-sale time period”) during which prices are lowered temporarily due to a time-limited sale, special offers for a limited time, or the like, the TO-DO task execution support portion 304 may notify the user of the special-sale time period in addition. Hereby, the user can execute the TO-DO task at a lower price by grasping the special-sale time period without search and changing the moving plan in accordance with the special-sale time period. As a result, the TO-DO task execution support server 30 can further improve the convenience for the user. Also, in terms of step S116 described later, a stop-off proposal, suitable for the moving plan, that proposes stop-off in the TO-DO-task related facility may be performed in the same manner.

More specifically, in step S108, the TO-DO task execution support portion 304 transmits, to the user terminal 40 of the user corresponding to the target moving plan, a signal (hereinafter referred to as “stop-off proposal notification request”) to request notification of a stop-off proposal that proposes stop-off in a TO-DO-task related facility suitable for the moving plan. Hereby, the TO-DO task execution support application portion 403 of the user terminal 40 can display, on the display device 46, a notification of the stop-off proposal that proposes stop-off in the TO-DO-task related facility suitable for the moving plan. At this time, the TO-DO task execution support application portion 403 provides, to the user via the input device 47, a notification to promote the user to select whether the user accepts or refuses the proposal. For example, the TO-DO task execution support application portion 403 displays, on a notification screen for the stop-off proposal, an icon for an operation to accept the proposal (hereinafter referred to as “acceptance icon”) and an icon for an operation to refuse the proposal (hereinafter referred to as “refusal icon”). Hereby, the user can select acceptance or refusal of the proposal by operating either of the acceptance icon and the refusal icon via the input device 47. The TO-DO task execution support application portion 403 then transmits a signal including a selection content (“acceptance” or “refusal”) by the user to the proposal to the TO-DO task execution support server 30. This may also apply to step S118 described later.

In step S110, the TO-DO task execution support portion 304 determines whether the selection operation to accept the proposal is performed or not within a predetermined time after the proposal in step S108, based on a notification received from the user terminal 40. At this time, in the user terminal 40, no selection might be performed on the proposal in step S108 and a display content on the display device 46 might be changed to a content other than the notification screen, or no selection operation might be performed even after the time has passed to some extent. In such cases, when the TO-DO task execution support portion 304 does not receive a signal indicative of the content of the selection operation from the user terminal 40 within a predetermined time, the TO-DO task execution support portion 304 may determine that the user refuses the proposal in step S108. This may also apply to steps S124, S142 described later. When the selection operation to accept the proposal is performed within the predetermined time after the proposal in step S108, the TO-DO task execution support portion 304 proceeds to step S112, and when the selection operation to accept the proposal is not performed, the TO-DO task execution support portion 304 ends the process.

In step S112, the TO-DO task execution support portion 304 registers a stop-off plan of the user to stop off in the TO-DO-task related facility in the schedule management server 10 so that the stop-off plan suits the moving plan of the user, and the TO-DO task execution support portion 304 ends this process. At this time, the TO-DO task execution support portion 304 may notify the user of the registration content (e.g., a content of the change of plan information) in the schedule management server 10 via the user terminal 40. For example, in a case where the moving plan is a plan to move, the TO-DO task execution support portion 304 may add information on the TO-DO-task related facility as a stop-off point (through-point) to plan information corresponding to the moving plan or may change date and time (specifically, departure date and time (departure time)), a moving route, or the like of plan information corresponding to the moving plan in consideration a stop-off time in the TO-DO-task related facility. Further, in a case where the moving plan is a plan necessary to be executed after the user moves from the base point, the TO-DO task execution support portion 304 may additionally register, before the moving plan, plan information corresponding to a stop-off plan to stop off in the TO-DO-task related facility or may change a moving route defined in plan information corresponding to the moving plan, departure date and time (departure time) of the moving route, or the like in consideration of a stop-off time in the TO-DO-task related facility so that the user can meet a start time of the moving plan. Further, the TO-DO task execution support portion 304 may propose changing the departure date and time (the departure time) or the moving route to the user, and when the user accepts the proposal, the TO-DO task execution support portion 304 may change the departure date and time or the moving route of the plan information. Hereby, the stop-off plan to stop off in the TO-DO-task related facility is automatically registered in the schedule management server 10. As a result, the TO-DO task execution support server 30 can improve the convenience for the user. Further, at the time of registering the stop-off plan to stop off in the TO-DO-task related facility, the stop-off time in the TO-DO-task related facility is taken into consideration so that the date and time of the target moving plan (e.g., an arrival time of the movement corresponding to the moving plan or a start time of the plan necessary to be executed after the user moves from the base point) does not change. As a result, the TO-DO task execution support server 30 can further improve the convenience for the user. Further, when the stop-off plan to stop off in the TO-DO-task related facility is registered in the schedule management server 10, a reminder related to the stop-off plan to stop off in the TO-DO-task related facility can be notified to the user terminal 40 from the schedule management server 10 in accordance with the moving plan. As a result, the TO-DO task execution support server 30 can further improve the convenience for the user.

More specifically, the TO-DO task execution support portion 304 transmits a plan information registration request to the schedule management server 10. Hereby, the plan information registration portion 101 of the schedule management server 10 can change and register plan information corresponding to the moving plan in the plan information storage portion 102 so that the plan information corresponds to the stop-off in the TO-DO-task related facility or can register new plan information corresponding to the stop-off in the TO-DO-task related facility in the plan information storage portion 102.

Further, as illustrated in FIG. 4B, in step S114, in a case where an execution deadline is set for the TO-DO task, the TO-DO task execution support portion 304 determines, based on plan information acquired by the plan information acquisition portion 301, whether or not a moving plan of the user (more specifically, a moving plan for which a moving route is not defined in the plan information) is included within a forward execution deadline. Further, in a case where the execution deadline is not set for the TO-DO task, the TO-DO task execution support portion 304 determines whether or not a moving plan of the user (more specifically, a moving plan for which a moving route is not defined in the plan information) is included within a forward predetermined period (e.g., within one week). When the moving plan of the user is included within the forward execution deadline or the forward predetermined period, the TO-DO task execution support portion 304 proceeds to step S114, and when the moving plan of the user is not included, the TO-DO task execution support portion 304 proceeds to step S128 (see FIG. 4C).

In step S116, the TO-DO task execution support portion 304 determines a geographical search area for the TO-DO-task related facility as a stop-off point for the moving plan and proceeds to step S118. For example, the TO-DO task execution support portion 304 may set the search area so that the search area includes a region around a destination of the user movement corresponding to the moving plan (e.g., a destination in a case of a plan to move or a visit place corresponding to a plan necessary to be executed after the user moves from the base point). Further, the TO-DO task execution support portion 304 may set the search area so that the search area includes a region around a departure place of the user movement corresponding to the moving plan (e.g., a departure place in a case of a plan to move or a place corresponding to another plan just before a plan necessary to be executed after the user moves from the base point). Further, the TO-DO task execution support portion 304 may grasp a home range of the user based on search resource information (movement history information) in the search resource information storage portion 303 and set the search area so that the search area includes the home range thus grasped. This is because, at the time of the user movement corresponding to the moving plan, the user is highly likely to departure from the home range or pass through the home range.

In step S118, the TO-DO task execution support portion 304 searches for a TO-DO-task related facility within the search area determined in step S116 and proceeds to step S120.

In step S120, the TO-DO task execution support portion 304 determines whether the TO-DO-task related facility is found or not in the process of step S118. When the TO-DO-task related facility is found, the TO-DO task execution support portion 304 proceeds to step S122, and when the TO-DO-task related facility is not found, the TO-DO task execution support portion 304 proceeds to step S128 (see FIG. 4C).

Similarly to the case of step S108, in step S122, the TO-DO task execution support portion 304 notifies, via the user terminal 40, the user of a stop-off proposal suitable for a moving plan to the found TO-DO-task related facility and proceeds to step S124.

In step S124, the TO-DO task execution support portion 304 determines whether a selection operation to accept the proposal is performed or not within a predetermined time after the proposal in step S122, based on a notification received from the user terminal 40. When the selection operation to accept the proposal is performed within the predetermined time after the proposal in step S122, the TO-DO task execution support portion 304 proceeds to step S126, and when the selection operation to accept the proposal is not performed, the TO-DO task execution support portion 304 ends the process.

Similarly to the step S112, in step S126, the TO-DO task execution support portion 304 registers a stop-off plan of the user to stop off in the TO-DO-task related facility in the schedule management server 10 so that the stop-off plan suits the moving plan of the user, and the TO-DO task execution support portion 304 ends the process.

Further, as illustrated in FIG. 4C, in step S128, the TO-DO task execution support portion 304 acquires positional information corresponding to a current position of the user from the search resource information storage portion 303 and proceeds to step S130.

In step S130, the TO-DO task execution support portion 304 determines, based on the plan information of the user, whether or not a current plan (e.g., a plan within a forward predetermined time from a current point of time as a starting point) is registered in the schedule management server 10. When the current plan is registered, the TO-DO task execution support portion 304 proceeds to step S132, and when the current plan is not registered, the TO-DO task execution support portion 304 proceeds to step S134.

In step S132, the TO-DO task execution support portion 304 determines a geographical search area for the TO-DO-task related facility as a stop-off point based on the current position of the user and the current plan of the user and proceeds to step S136. For example, the TO-DO task execution support portion 304 may set, as the search area, a range where the user can move from the current position within a predetermined time in consideration of a finish time of the current plan. Further, the TO-DO task execution support portion 304 may determine the search area in consideration of the home range of the user as described above.

In the meantime, in step S134, the TO-DO task execution support portion 304 determines a geographical search area for the TO-DO-task related facility as a stop-off point based on the current position of the user and proceeds to step S136. For example, the TO-DO task execution support portion 304 may set, as the search area, a range where the user can move from the current position of the user within a predetermined time. Further, the TO-DO task execution support portion 304 may determine the search area in consideration of the home range of the user as described above.

In step S136, the TO-DO task execution support portion 304 searches for a TO-DO-task related facility within the search area determined in step S132 or step S134 and proceeds to step S138.

In step S138, the TO-DO task execution support portion 304 determines whether the TO-DO-task related facility is found or not in the process of step S136. When the TO-DO-task related facility is found, the TO-DO task execution support portion 304 proceeds to step S140, and when the TO-DO-task related facility is not found, the TO-DO task execution support portion 304 ends this process.

In step S140, the TO-DO task execution support portion 304 notifies, via the user terminal 40, the user of a stop-off proposal to stop off in the TO-DO-task related facility thus found and proceeds to step S142. More specifically, the TO-DO task execution support portion 304 transmits a stop-off proposal notification request to the user terminal 40 of the target user, similarly to the case of step S116 and the like. At this time, in a case where a plurality of TO-DO-task related facilities is found, the TO-DO task execution support portion 304 may propose all the TO-DO-task related facilities as stop-off points or may propose some of the TO-DO-task related facilities as stop-off points. For example, the TO-DO task execution support portion 304 may propose, as stop-off points, only some TO-DO-task related facilities relatively close to the current position of the user. Further, in a case where the user has to pay money for execution of the TO-DO task to the TO-DO-task related facility, the TO-DO task execution support portion 304 may propose some TO-DO-task related facilities available at a relatively low price, a TO-DO-task related facility available at a lowest price, or the like as stop-off points. Further, in a case where a TO-DO-task related facility to be proposed has a special-sale time period, the TO-DO task execution support portion 304 may notify the user of the special-sale time period as well.

In step S142, the TO-DO task execution support portion 304 determines whether or not a selection operation to accept the proposal is performed within a predetermined time after the proposal in step S140, based on a notification received from the user terminal 40. When the selection operation to accept the proposal is performed within the predetermined time after the proposal in step S140, the TO-DO task execution support portion 304 proceeds to step S144, and when the selection operation to accept the proposal is not performed, the TO-DO task execution support portion 304 ends this process.

In step S144, the TO-DO task execution support portion 304 registers a stop-off plan of the user to stop off in the TO-DO-task related facility in the schedule management server 10 and ends this process. For example, in a case where there is a current plan, the TO-DO task execution support portion 304 may designate date and time after a finish time of the current plan in consideration of a moving time from the current position and register plan information corresponding to the stop-off plan of the user to stop off in the TO-DO-task related facility in the schedule management server 10. Further, in a case where there is no current plan, the TO-DO task execution support portion 304 may designate date and time in consideration of a current time and a moving time from the current position to the TO-DO-task related facility and register plan information corresponding to the stop-off plan of the user to stop off in the TO-DO-task related facility in the schedule management server 10. More specifically, the TO-DO task execution support portion 304 transmits a plan information registration request to the schedule management server 10. Hereby, the plan information registration portion 101 of the schedule management server 10 can register new plan information of the user that corresponds to the stop-off in the TO-DO-task related facility in the plan information storage portion 102.

Operation of Present Embodiment

Next will be described the operation of the TO-DO task execution support system 1 (the TO-DO task execution support server 30) according to the present embodiment.

In the present embodiment, the plan information acquisition portion 301 and the TO-DO task information acquisition portion 302 acquire plan information of the user and TO-DO task information, respectively. The TO-DO task execution support portion 304 notifies, via the user terminal 40, the user of information on a TO-DO-task related facility around a moving route corresponding to a forward moving plan of the user that is included in the plan information, in association with the moving plan.

Hereby, the TO-DO task execution support server 30 can notify the user that the user can stop off in the TO-DO-task related facility around the moving route corresponding to the forward moving plan of the user. On this account, the user can plan to stop off in the facility beforehand in accordance with the moving plan of the user. Accordingly, the TO-DO task execution support server 30 can make a proposal related to execution of a TO-DO task at a more appropriate timing.

Further, in the present embodiment, in a case where a moving route to a destination is defined in plan information corresponding to the moving plan, the TO-DO task execution support portion 304 may notify the user of information of a TO-DO-task related facility placed along the moving route, in association with the moving plan.

Hereby, the TO-DO task execution support server 30 can propose a facility placed along a specifically defined moving route corresponding to the moving plan for the purpose of execution of the TO-DO task.

Further, in the present embodiment, the TO-DO task execution support portion 304 may notify the user of the TO-DO-task related facility placed along the moving route as a through-point between a departure place and a destination corresponding to the moving plan and may notify the user of a change of departure date and time (a departure time) or a change of the moving route, the change being made so that arrival date and time (an arrival time) at the destination does not change.

Hereby, the TO-DO task execution support server 30 can notify the user of the change of the departure date and time or the change of the moving route in consideration of a stop-off time in the TO-DO-task related facility, in addition to the notification of the facility placed along the specifically defined moving route, for the purpose of execution of the TO-DO task. As a result, the TO-DO task execution support server 30 can improve the convenience for the user.

Further, in the present embodiment, in a case where the moving route is not defined in the plan information corresponding to the moving plan, the TO-DO task execution support portion 304 may notify the user of information on a TO-DO-task related facility placed around at least either of the departure place and the destination corresponding to the moving plan, in association with the moving plan.

Hereby, in a case where a specific moving route is not defined for the moving plan, the TO-DO task execution support server 30 can propose a facility placed around the departure place or the destination in which the user can stop off, for the purpose of execution of the TO-DO task.

Further, in the present embodiment, in a case where a moving route to the destination is not defined in the plan information corresponding to the moving plan, the TO-DO task execution support portion 304 may notify the user of information on a TO-DO-task related facility placed within a home range of the user, in association with the moving plan, the home range being grasped from a past movement history of the user.

Hereby, in a case where a specific moving route is not defined for the moving plan, the TO-DO task execution support server 30 can propose a facility, within the home range, that is highly likely to be used by the user as at least part of the moving route from the departure place to the destination, for the purpose of execution of the TO-DO task.

Further, in the present embodiment, the TO-DO task execution support portion 304 may notify the user of information on a TO-DO-task related facility around the moving route corresponding to the moving plan so that the amount of money that the user is to pay to the TO-DO-task related facility is relatively restrained.

Hereby, the TO-DO task execution support server 30 can improve the convenience for the user.

Further, in the present embodiment, in a case where there is a plurality of TO-DO-task related facilities around the moving route corresponding to the moving plan, the TO-DO task execution support portion 304 may notify the user of information on facilities to which the user should pay a relatively small amount of money.

Hereby, the TO-DO task execution support server 30 can specifically restrain the amount of money that the user is to pay to the TO-DO-task related facility.

Further, in the present embodiment, the TO-DO task execution support portion 304 may notify the user of a time period during which the amount of money that the user should pay to a facility related to execution of a TO-DO task around the moving route corresponding to the moving plan is relatively small.

Hereby, in addition to the proposal of the facility around the moving route, the TO-DO task execution support server 30 can notify the user of a time period during which the amount of money to be paid for a product or a service is reduced in the facility, e.g., a time period for a time-limited sale or special offers for a limited time. Accordingly, the TO-DO task execution support server 30 can specifically restrain the amount of money that the user is to pay to the TO-DO-task related facility.

The embodiment has been described above in detail, but the present disclosure is not limited to such a specific embodiment, and various modifications and alterations can be made within the gist of the present embodiments and Claims.

For example, in the above embodiment, the functions of the schedule management server 10 and the TO-DO task management server 20 may be unified in one server device.

Further, in the above embodiment and modification, the function of the TO-DO task execution support server 30 may be unified with the schedule management server 10 (one example of the information processing device), the TO-DO task management server 20 (one example of the information processing device), or a server device (one example of the information processing device) in which the functions of the schedule management server 10 and the TO-DO task management server 20 are unified.

Further, in the above embodiment, the function of the TO-DO task execution support server 30 (the plan information acquisition portion 301, the TO-DO task information acquisition portion 302, and the TO-DO task execution support portion 304) may be provided in the TO-DO task execution support application portion 403 of the user terminal 40 (one example of the information processing device) of each user, for example.

What is claimed is:

1. An information processing device comprising:
a TO-DO task information acquisition portion configured to acquire information about an unexecuted TO-DO task of a user;
a plan information acquisition portion configured to acquire information about a forward plan of the user; and
a notification portion configured to notify, via a user terminal, the user of information on a facility related to execution of the TO-DO task in association with a plan accompanied with movement in the forward plan, the facility related to execution of the TO-DO task being placed around a moving route corresponding to the plan accompanied with movement.

2. The information processing device according to claim 1, wherein, in a case where the moving route is defined in information corresponding to the plan accompanied with movement, the information being acquired by the plan information acquisition portion, the notification portion notifies the user of information on a facility related to execution of the TO-DO task and placed along the moving route, in association with the plan accompanied with movement.

3. The information processing device according to claim 2, wherein:
the notification portion notifies the user of the facility related to execution of the TO-DO task and placed along the moving route as a through-point between a departure place and a destination corresponding to the plan accompanied with movement; and
the notification portion notifies the user of a change of departure date and time or a change of the moving route, the change being made so that arrival date and time at the destination does not change.

4. The information processing device according to claim 1, wherein, in a case where the moving route is not defined in information corresponding to the plan accompanied with movement, the information being acquired by the plan information acquisition portion, the notification portion notifies the user of information on a facility related to execution of the TO-DO task and placed around at least either one of a departure place and a destination corresponding to the plan accompanied with movement, in association with the plan accompanied with movement.

5. The information processing device according to claim 1, wherein, in a case where the moving route is not defined in information corresponding to the plan accompanied with movement, the information being acquired by the plan information acquisition portion, the notification portion notifies the user of information on a facility related to execution of the TO-DO task and placed within a home range of the user in association with the plan accompanied with movement, the home range being grasped from a past movement history of the user.

6. The information processing device according to claim 1, wherein the notification portion notifies the user of information on the facility related to execution of the TO-DO task and placed around the moving route so that an amount of money that the user is to pay to the facility related to execution of the TO-DO task is relatively restrained.

7. The information processing device according to claim 6, wherein, in a case where there is a plurality of facilities related to execution of the TO-DO task around the moving route, the notification portion notifies the user of information on facilities to which the user is to pay a relatively small amount of money.

8. The information processing device according to claim 6, wherein the notification portion notifies the user of a time period during which the user is to pay a relatively small amount of money to the facility related to execution of the TO-DO task and placed around the moving route.

9. An information processing method executed by an information processing device, the information processing method comprising:
a TO-DO task information acquisition step of acquiring information about an unexecuted TO-DO task of a user;
a plan information acquisition step of acquiring information about a forward plan of the user; and
a notification step of notifying, via a user terminal, the user of information on a facility related to execution of the TO-DO task in association with a plan accompanied with movement in the forward plan, the facility related to execution of the TO-DO task being placed around a moving route corresponding to the plan accompanied with movement.

10. A program for causing an information processing device to execute:
a TO-DO task information acquisition step of acquiring information about an unexecuted TO-DO task of a user;
a plan information acquisition step of acquiring information about a forward plan of the user; and
a notification step of notifying, via a user terminal, the user of information on a facility related to execution of the TO-DO task in association with a plan accompanied with movement in the forward plan, the facility related to execution of the TO-DO task being placed around a moving route corresponding to the plan accompanied with movement.
